(19) United States
(12) Patent Application Publication
(10) Pub. No.: US 2011/0036413 A1
(43) Pub. Date: Feb. 17, 2011

(54) WATER-CONDUCTING HOUSEHOLD APPLIANCE AND METHOD FOR OPERATING A WATER-CONDUCTING HOUSEHOLD APPLIANCE

(75) Inventors: Helmut Jerg, Giengen (DE); Peter Jochimski, Nattheim (DE); Karlheinz Rehm, Dischingen Ortst. Trugenhofen (DE); Michael Rosenbauer, Reimlingen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH BOSCH UND SIEMENS HAUSGERATE GMBH, Munich (DE)

(21) Appl. No.: 12/846,863

(22) Filed: Jul. 30, 2010

(30) Foreign Application Priority Data
Aug. 17, 2009 (DE) 10 2009 028 586.5

(51) Int. Cl. F15D 1/00; G05D 23/13

(52) U.S. Cl. 137/3; 236/12.14

(57) ABSTRACT

A water-conducting household appliance having at least one water-conducting component; a hot water connection having a first feed valve to connect the household appliance to a hot water network and a first inlet line connecting the first feed valve to the at least one water-conducting component; and a cold water connection having a second feed valve to connect the household appliance to a cold water network and a second inlet line connecting the second feed valve to the at least one water-conducting component. A temperature measurement facility is disposed in the hot water connection and measures a temperature of hot water from the hot water network.

### BACKGROUND OF THE INVENTION

The invention relates to a water-conducting household appliance and to a method for operating a water-conducting household appliance.

In conventional dishwashers the water temperature is measured within the dishwasher, e.g. in a pump well. To do this it is necessary to let a proportion of the water needed for each washing cycle pass into the interior of the dishwasher in order to enable the water temperature to be measured. If the dishwasher has a bithermal water connection, i.e. a cold and a hot water connection, then the temperature of the water coming from the hot water connection is not generally known. In order to prevent delicate items to be washed being exposed to water which is too hot, a certain proportion of cold water is also used, even if this would be unnecessary because of the temperature of the hot water.

DE 102 26 736 A1 discloses an open-loop and/or closed-loop temperature control of water in a water feed of a household washing machine or a household dishwasher. The water feed comprises a cold water line and a hot water line which are designed as feed lines for an adjustable mixer valve. Only one line embodied as an outlet leads away from the mixer valve. The mixer valve is connected to an open-loop/closed loop control facility, to which a temperature sensor for determining the actual temperature of the water mixed by the mixer valve is assigned. A target temperature can be set in the control facility so that the control facility actuates the mixer valve as a function of the actual temperature and the target temperature.

EP 0 860 535 A2 discloses a valve which is designed for a washing machine or a dishwasher. The valve comprises a temperature measurement facility for measuring the temperature of the water flowing through the valve.

### BRIEF SUMMARY OF THE INVENTION

The object of the invention is to specify a water-conducting household appliance, preferably with a hot water connection and a cold water connection, in which the temperature of the water intended for the household appliance can be better determined.

The object of the invention is achieved by a water-conducting household appliance featuring a hot water connection having a first feed valve to connect the household appliance to a hot water network and a first inlet line connecting the first feed valve to one or more water-conducting components of the household appliance, and a cold water connection having a second feed valve for connecting the household appliance to a cold water network and a second inlet line connecting the second feed valve to one or more water-conducting components of the household appliance, as well as a first temperature measurement facility disposed in the hot water connection which is configured to measure the temperature of the hot water coming from the hot water network. The inventive household appliance is preferably a dishwasher, but can also be a washing machine for example.

The inventive household appliance accordingly comprises two water connections, namely a cold water connection and a hot water connection, with which the inventive household appliance can be connected to the water network in each case. The hot water connection is designed to be connected to a water network delivering preheated water, e.g. warm or even hot water. The term “water network” is intended to be widely understood here. The preheated water of the hot water network can thus also originate from a domestic water heater or a hot water supply system which is supplied partly or entirely with energy by a solar power system, especially a thermal solar power system.

The two water connections each have a feed valve and an inlet line. The inventive household appliance can be connected to the hot water or to the cold water network by the feed valves which are embodied as magnetic valves, especially Aquastop valves for example. The water originating from the water networks thus flows via the feed valves and the inlet lines to the water-conducting components of the inventive household appliance. The water-conducting components in the case of the dishwasher generally comprise its washing compartment. The inlet lines are typically water hoses. To prevent water damage as a result of a leaking water hose, the water hoses embodied as inlet lines can run within covering hoses.

To now enable the temperature of the water coming from the hot water network to be reliably determined, especially before it reaches the water-conducting components of the inventive household appliance, the latter has the first temperature measurement facility which is disposed in the hot water connection, especially integrated therein.

The first temperature measurement facility is thus integrated into the first inlet line or, as provided for in a preferred variant of the inventive household appliance, disposed in the first feed valve, especially integrated into the latter. It is thus possible to directly measure the actual inlet temperature of the water coming from the hot water network as soon as this flows into the inventive household appliance and before it reaches the washing container for example. This allows it to be determined more precisely than before, with a simple measurement in a device-internal, water-conducting component such as in the respective processing chamber of the household appliance, especially in the washing container of a dishwasher for example, whether cold water is to be supplied, and if so how much, from a cold water connection for a specific quantity of hot water fed in to enable a specific operating or processing temperature to be reached. This is because, before the inlet cycle of the inflowing hot water into the household appliance is ended, especially right at the beginning of the intake of the hot water through the water inlet line or even as the hot water is flowing into the hot water feed valve itself, the inlet temperature of the water can be determined by means of the temperature measurement facility. A control facility in the household appliance can especially determine by means of the measured inlet temperature of the hot water how much cold water is to be introduced from the cold water network in parallel to the hot water intake or after completion of the hot water intake into the household appliance in order to enable a desired amount of water with a specific target temperature to be provided. To this end the control facility expediently includes one or more further parameters, such as the water pressure of the hot water network and/or cold water network, the inlet cross-section of the hot water and/or cold water feed line, . . . etc. for example, and/or the length of time for which hot water and/or cold water is fed in. In this way, in a precisely controllable manner, in at least one water-conducting component of the respective household appliance, such as in the washing container of a dishwasher for example, for the respective part wash cycle of a selected dishwashing program, a desired overall quantity of water with an actual temperature can be introduced which largely corresponds to a required target temperature. It is now no longer necessary to wait until the hot water fully reaches at least one device-internal, water-conducting component of the household appliance such as a device-internal water circulation system, preferably in the washing container of a dishwasher for example, to be able to only then measure the temperature. This avoids having to supply an additional quantity of cold water to the household appliance and thus an overfilling, i.e. too great a total quantity of water than is actually required in the household appliance, if because of the device-internal temperature measurement too high a hot water temperature in the household appliance had been established. This enables incorrect information or deviations in respect of the actual quantity of water supplied to the respective household appliance and/or its actual temperature in relation to a desired target overall quantity of water and/or target temperature to be largely avoided. The inventive, especially device-external temperature measurement facility, also makes possible fast reaction times for any addition of cold water to the inflowing hot water quantity in order to enable a specific target temperature for the quantity of hot water arriving in the household appliance overall and if necessary additionally supplied cold water to be set.

The first temperature measurement facility can advantageously typically be an NTC thermistor, i.e. a resistor of which the resistance falls as the temperature drops.

In accordance with a preferred form of embodiment of the inventive household appliance, this features a control device connected to at least the second feed valve and the first temperature measurement facility for controlling the operation of the household appliance which is configured, depending on the temperature measured with the first temperature measurement facility, to control the second feed valve in order to control an intake of cold water originating from the cold water network. If the water originating from the hot water network is too hot, for a currently selected washing program for example in the case of a dishwasher embodied as an inventive household appliance, then in accordance with this form of embodiment, cold water is to be mixed with the warm water or hot water in accordance with a desired mixing temperature.

For this expedient variant of the inventive household appliance there can especially be provision for the control facility only to open the second feed valve for an inflow of cold water when the temperature measured with the first temperature measurement facility undershoots a threshold value especially assigned to a current setting of the household appliance. If the temperature of the warm water or the hot water is below this threshold value, it is not necessary to mix cold water in with the warm or hot water. This has a positive effect on the energy efficiency of the inventive household appliance. The current settling of the household appliance is for example a currently selected washing program, especially a delicate program in the case of the dishwasher, or a currently selected washing program in the case the washing machine.

The control facility can also be configured, in accordance with an advantageous development of the invention, to control the second feed valve as a function of the current setting of the household appliance in order to control the intake of the cold water coming from the cold water network.

The quantity of cold water supplied can especially be estimated. In accordance with a further form of embodiment of the inventive household appliance, this appliance features a second temperature measurement facility disposed in the cold water connection which is configured to measure the temperature of the cold water coming from the cold water network, which then makes it possible for example for the control facility to be configured to control the second feed valve as a function of the temperature measured with the second temperature measurement facility in order to control an intake of the cold water coming from the cold water network. Consequently the necessary quantity of cold water can be adapted if necessary to the current temperature of the cold water.

The second temperature measurement facility is thus disposed especially in the second inlet line or, as is provided for in a preferred variant of the inventive household appliance, in the second feed valve, especially being integrated into the latter. It is thus possible to measure the temperature of the water coming from the cold water network as soon as this flows into the inventive household appliance.

The feed valves and the inlet lines can preferably form a water stop system, especially the Aquastop system. This is because the system where necessary provides a safety mechanism in order to prevent the inflow of water in the event of a defect, especially in the inlet lines embodied as water hoses, in that the control device automatically blocks the feed valves.

A further aspect of the invention relates to a method for operating a household appliance, having the following method steps:

Measuring the water temperature of the hot water supplied, and

Setting a supply of cold water as a function of the measured water temperature of the hot water.

The household appliance is for example a dishwasher or a washing machine and is especially embodied in accordance with the inventive household appliance.

The cold water can be supplied advantageously as a function of a current setting of the household appliance. The current setting of the household appliance is for example a currently selected dishwashing program in the case of a dishwasher or a currently selected wash program in the case of a washing machine.

The cold water is only supplied in accordance with an advantageous variant of the inventive method if the measured water temperature of the hot water exceeds a threshold, especially a threshold assigned to a current setting of the household appliance.

For an improved dispensing of the quantity of supplied cold water there can expediently be provision for measuring the water temperature of the supplied cold water and setting the supply of cold water as a function of its measured water temperature.

Depending on the form of embodiment of the inventive household appliance, there is thus provision to dispose a temperature measurement sensor (temperature measurement facility) e.g. in the form of an NTC component relatively far forward in the hot water intake, e.g. in the feed valve (especially Aquastop), in order to enable the temperature of the inflowing water to be measured at the earliest possible time. In addition a further temperature measurement facility, e.g. an NTC component, can be provided in the cold water feed.

This makes it possible to measure the water temperature at the hot water inlet from the first drop onwards. For the operation of the inventive household appliance, especially when it involves a dishwasher, preferably a household dishwasher, there can be provision, if the hot water temperature is below a threshold value, in particular a program-dependent threshold value, to have the household appliance, especially the dishwasher, filled completely from the hot water inlet. The dishwasher thus operates with minimum energy consumption or with maximum energy efficiency.

If the hot water temperature lies above a threshold value, especially a program-dependent threshold value, there can expediently be provision for the filling of the inventive household appliance to be undertaken by mixing in an estimated amount of cold water. The dishwasher still operates with a reduced energy consumption, but the items to be washed are protected. This is especially advantageous for a delicate dishwasher program such as washing glasses for example. In addition any possible cold connection of the supply can be recognized and the method can react to this. In particular a cold connection of the hot water supply line or of the hot water feed valve can indicate that the hot water supply system has failed or been switched off. This information can be included by the control facility of the household appliance for setting or adjusting one or more operational sequence steps. Thus for example a dishwasher can change to washing programs which activate a device-internal electrical heating device for heating up washing water.

If the temperature of the cold water in the cold water feed is especially also measured, a desired water inlet temperature can be set more precisely, especially even with a low, if not a minimal consumption of cold water. This reduces, if not minimizes, the consumption of energy.

Other embodiments and developments of the invention are reflected in the subclaims. These, as well as the advantageous embodiments and developments of the invention listed above, can be used individually or in any combination in an inventive household appliance, especially in an inventive dishwasher.

The invention and its embodiments and developments and their advantages will be explained in greater detail below with reference to drawings.

### BRIEF DESCRIPTION OF THE DRAWINGS

The respective figures show schematic diagrams as follows:

FIG. 1. a household dishwasher with an advantageous embodiment variant of an inventive water supply system, and

FIG. 2 the water supply system of the household dishwasher from FIG. 1 in detail.

### DETAILED DESCRIPTION OF EXEMPLARY EMBODIMENTS OF THE PRESENT INVENTION

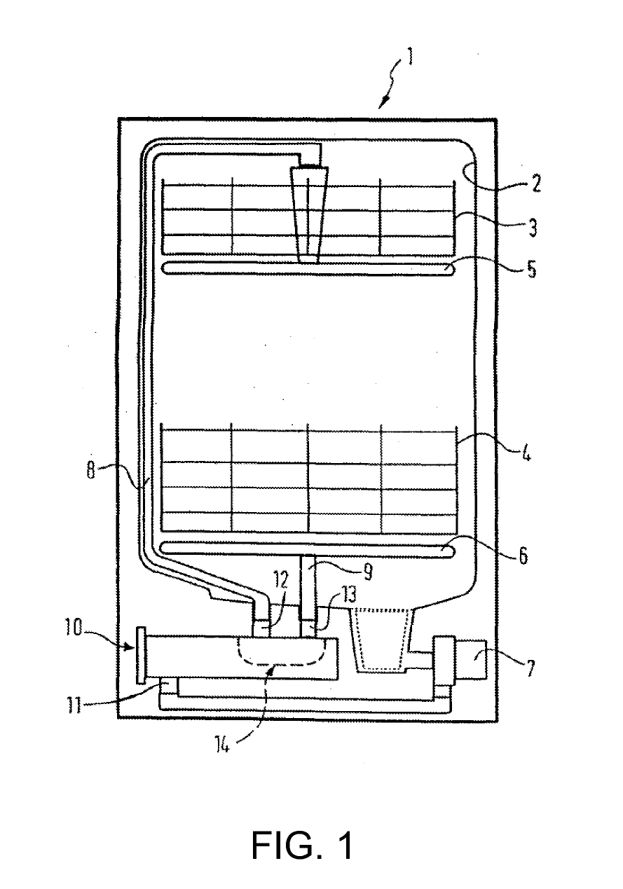

FIG. 1 shows a sectional diagram of a household dishwasher 1 as an example of a water-conducting household appliance.

The household dishwasher 1 has a washing container 24 for holding items to be washed, which can be arranged in a crockery basket 3 and a lower crockery basket 4 for example. At least two spray arm devices are disposed in the washing container 2 for applying a liquid, usually referred to as washing liquor, to the items to be washed. In the case of the present exemplary embodiment the spray devices are embodied as upper and lower spray arms 5, 6. The liquid can be conveyed from a circulation pump 7 via a first liquid line 8 to the upper spray arm 5 and via a second liquid line 9 to the lower spray arm 6. The circulation pump 7 is driven for example by an electrical drive not shown in any greater detail, especially by its electric motor.

In the case of the present exemplary embodiment the liquid is at least heated up in a subprogram step of a washing program of the household dishwasher 1 by a continuous flow heater 10, which is connected by an inlet nozzle 11 to the circulation pump 7 and by outlet nozzles 12, 13 to the liquid feed lines 8, 9. The number of output nozzles 12-13 corresponds to the number of spray arms 5, 6 or groups of spray arms 5, 6 operated at the same time. The liquid conveyed by the circulation pump 7 is therefore in the case of the present exemplary embodiment directed to the inlet nozzle 11 of the continuous flow heater 10 and from its outlet nozzles 12, 13 via the liquid feed lines 8, 9 to the spray arms 5, 6.

The household dishwasher 1 further features a water switch 14 which is arranged for example in the continuous flow heater 10 or is molded onto the latter. The water switch 14 can for example however also be arranged on its own in the household dishwasher 1 or be connected directly to the circulation pump 7. The washing container 2, the circulation pump 7, the spray arms 5, 6, the through-flow heater 10 and the water switch 14 form water-conducting components of the household dishwasher 1.

By means of the water switch 14 the spray arms 5, 6 can each be alternately and/or constantly supplied with the liquid, which is achieved by opening the liquid outlet and by closing the other liquid outlet of the water switch 14.

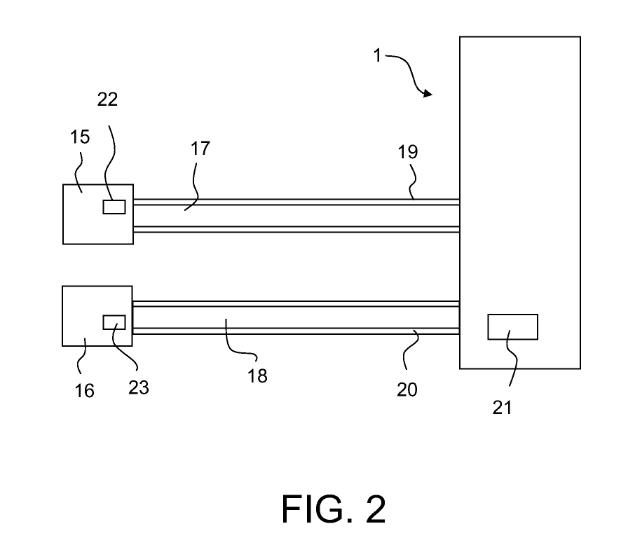

FIG. 2 shows a water feed system of the household dishwasher 1 with a number of water connections.

In the case of the present exemplary embodiment the water system comprises a number of water connections, especially in the form of a first feed valve 15 and a second feed valve 16. The feed valves 15, 16 are typically magnetic valves, especially Aquastop valves and are connected for example to a control facility 21 of the household dishwasher 1, via lines, especially data and/or control lines not shown in any greater detail. The control facility 21 is configured for control of functions such as the operation of the household dishwasher 1 and selective opening and closing of the feed valves 15, 16.

The two feed valves 15, 16 are designed to be connected to water supply systems, especially water networks, not described in any greater detail. One of the feed valves 15, 16 can for example be connected to a cold water connection of a drinking water network and the other to a hot water connection of a hot water supply network, especially a hot water supply system such as a tank of the heating system of a building, in order to supply the household dishwasher 1 with cold or with preheated water.

In the case of the present exemplary embodiment, the water feed system of the domestic dishwasher 1 comprises two water inlet lines, e.g. in the form of a first water hose 17 which is connected to the first feed valve 15, and a second water hose 18, which is connected to the second feed valve 16. The ends of the water hoses 17, 18 facing away from the feed valves 15, 16 are preferably connected to separate device inlets or to a common device inlet of the household dishwasher 1 and thereby to water-conducting components of the household dishwasher 1. The water coming from the water connections arrives in the washing container 2 via the device inlet in order, when mixed with a washing agent, to form the washing liquor.

The water feed system can be embodied as a water stop system and can accordingly comprise a safety mechanism in order, in the event of the defect in the water hoses, to especially prevent the intake of water, in that the control facility 21 automatically blocks the feed valves 15, 16 for example. For this purpose the two water hoses 17, 18 can run within covering hoses 19, 20, which are corrugated hoses for example. If the water hoses 17, 18 are not watertight the covering hoses 19, 20 can catch the escaping water. The lines by which the feed valves 15, 16 are connected to the control facility 21 can likewise run within the covering hoses 19, 20.

In the case of the present exemplary embodiment a temperature measurement sensor (in general terms: temperature measurement facility) 22 is integrated into the first feed valve 15 which is intended to be connected to the hot water network or the hot water supply system, which is connected via a line not shown in any greater detail, which runs within the covering hose 19 for example, to the control facility 21. The temperature measurement sensor 22, which for example comprises an NTC thermistor, is designed to measure the inlet water temperature of the water flowing in through the first feed valve 15, i.e. to measure the temperature of the hot water.

The control facility 21 is configured in its turn, on the basis of the measured water temperature of the hot water, to control the second feed valve 16 which is designed to be connected to the cold water network. The control facility 21 is thus configured, depending on the water temperature of the hot water, to set the water intake of the cold water so that for example the temperature of the water provided for the washing container 2 is not too high for the current items to be washed, such as delicate glasses for example. In particular the control facility 21 can be configured to control the second feed valve 16 so that the intake of cold water does not only depend on the measured temperature of the hot water but also on the dishwashing program selected.

In the case of the present exemplary embodiment there is especially provision for the control facility 21 to compare the measured water temperature of the hot water with a threshold value and only to control the second feed valve 16 for an intake of cold water if the measured water temperature of the hot water lies above the threshold value. The threshold value can especially depend on the washing programs selected. The necessary quantity of cold water can in particular be estimated as a function of the temperature of the hot water.

In addition there can also be provision for a further temperature measurement sensor (in general terms: temperature measurement facility) 23 to be integrated into the second feed valve 16, which is designed to be connected to the cold water network, which is connected via a line not shown in any greater detail which runs within the covering hose 20 for example to the control facility 21. The temperature measurement sensor 23, which typically comprises an NTC thermistor, is provided for measuring the cold water flowing through the second feed valve 16, i.e. to measure the temperature of the cold water.

Because of this embodiment it is possible for the control facility 21 to control the second feed valve 16 more precisely, i.e. to adapt the quantity of cold water more precisely to the current temperatures of the hot water and of the cold water.

The temperature measurement sensor 22 and if necessary the temperature measurement sensor 23 can also be disposed in the water hose 17 or in the water hose 18, especially integrated therein. Although a household dishwasher 1 has been shown and described as an example of a water-conducting household appliance, the household appliance can especially also be a washing machine. In this case the control facility of the washing machine can be configured for example to adapt the threshold value or the quantity of cold water supplied to the selected wash program.

What is claimed is:

1. A water-conducting household appliance, comprising:
at least one water-conducting component;
a hot water connection having a first feed valve to connect the household appliance to a hot water network and a first inlet line connecting the first feed valve to the at least one water-conducting component; and
a cold water connection having a second feed valve to connect the household appliance to a cold water network and a second inlet line connecting the second feed valve to the at least one water-conducting component;
wherein a first temperature measurement facility is disposed in the hot water connection, the first temperature measurement facility to measure a temperature of hot water from the hot water network.

2. The household appliance of claim 1, wherein the household appliance is one of a dishwasher and a washing machine.

3. The household appliance of claim 1, wherein the first temperature measurement facility is disposed in the first feed valve.

4. The household appliance of claim 3, wherein the first temperature measurement facility is integrated into the first feed valve.

5. The household appliance of claim 1, wherein the first temperature measurement facility is an NTC thermistor.

6. The household appliance of claim 1, further comprising a control facility connected to at least the second feed valve and the first temperature measurement facility to control operation of the household appliance, the control facility to control the second feed valve in order to control an intake of cold water from the cold water network, depending on the temperature measured by the first temperature measurement facility.

7. The household appliance of claim 6, wherein, depending on a current setting of the household appliance, the control facility is configured to control the second feed valve in order to control the intake of the cold water from the cold water network.

8. The household appliance of claim 6, wherein the control facility only opens the second feed valve for an inflow of the cold water if the temperature measured by the first temperature measurement facility exceeds a threshold value assigned to a current setting of the household appliance.

9. The household appliance of claim 1, further comprising a second temperature measurement facility disposed in the cold water connection, the second temperature measurement facility to measure a temperature of cold water from the cold water network.

10. The household appliance of claim 9, wherein the second temperature measurement facility at least one of is disposed in the second feed valve and comprises an NTC thermistor.

11. The household appliance of claim 10, wherein the second temperature measurement facility is integrated into the second feed valve.

12. The household appliance of claim 9, wherein, depending on the temperature measured by the second temperature measurement facility, a control facility is structured to activate the second feed valve in order to control an intake of the cold water from the cold water network.

13. The household appliance of claim 1, wherein at least one of the hot water connection and the cold water connection form a water stop system.

14. A method for operating a household appliance, the method comprising:
measuring a water temperature of hot water supplied to the household appliance; and
setting an intake of cold water as a function of the measured water temperature of the hot water.

15. The method of claim 14, wherein the intake of the cold water is set as a function of a current setting of the household appliance.

16. The method of claim 14, wherein the cold water is supplied only if the measured water temperature of the hot water exceeds a threshold value assigned to a current setting of the household appliance.

17. The method of claim 14, further comprising:
measuring a water temperature of cold water supplied to the household appliance; and
setting the intake of the cold water as a function of the measured water temperature of the cold water.
